(19) United States
(12) Patent Application Publication
(10) Pub. No.: US 2004/0051845 A1
(43) Pub. Date: Mar. 18, 2004

(54) Eyeglasses having retractable cord

(76) Inventor: Mike Steere, Sacramento, CA (US)

Correspondence Address: Donald W. Meeker, 750 La Playa, # 512, San Francisco, CA, 94121, US

(21) Appl. No.: 10/233,042

(22) Filed: Aug. 30, 2002

(51) Int. Cl. G02C 3/00

(52) U.S. Cl. 351/157

(57) ABSTRACT

A pair of eyeglasses, which could be sun glasses, has a spring-loaded roller in at least one arm with a cord rollable on the chord. A connector on the end of the cord attaches to a mating receiving means on the other arm. The connector, which could be a small sphere, prevents the cord from fully entering the arm. A roller could be positioned within each arm and the two cords interconnected by a hook connector. A brake arm can be pushed or pulled to retain the roller in a stationary position or release it for rolling up the cord. A double roller could be used in the arm.

### BACKGROUND OF THE INVENTION

1. Field of the Invention

The present invention relates to eyeglasses and in particular for a retractable cord built into one or both arms of any type of eyeglasses including sun glasses.

2. Description of the Prior Art

Eyeglasses, including sun glasses are just balanced on the nose and ears with some holding ability provided by the tightness of fit of the bent outer ends of the arms of the glasses, which becomes very uncomfortable if too tight. In response various types of stretch bands have been developed to attach to the arms of the glasses with the stretch cord extending around the head to secure the glasses in place on the wearer and help prevent the dislodging of the glasses. This is especially helpful in situations of high activity, such as participation in athletic events, or in situations requiring extreme tilting of the head, such as working under vehicles.

Eyeglasses are also quite fragile and storing the glasses is a problem. If the glasses are not kept on the person in an attachable case or a case in the pocket, glasses are easily misplaced and not easily found sometimes. Because of the fragility of the glasses, they are sometimes damaged when stored in a pocket or could even fall out. In response to this problem, non-elastic straps have been developed to attach to the ends of the arms of the glasses so that the glasses can be taken off and worn hanging from the neck of the wearer, so they are easily found for use and not as easy to break as when the glasses are stored in a pocket, especially a pants pocket.

A number of prior art patents address these problems but none effectively address both problems.

U.S. Pat. No. 5,898,472, issued Apr. 27, 1999 to Hidetoshi Oshikawa, provides an eyeglass holding device (7) has a strap (4′) with a clip for attaching the strap end to an eyeglass frame (1′). The strap feeds in and out of a housing (8) which contains reel (14) on which the cord winds. The housing is detachably mounted on a hat or shirt for example with VELCRO. The strap winding mechanism inside the housing includes a torsion spring (21) for retracting the strap back into the housing; a ratchet (18) and pawl (17) acting as lock to stop the spring from pulling the strap in once it is pulled out; and a button (16) to release the lock. The eyeglasses can be pulled to bring out any length of the straps. The torsion spring retracts the cords while the button is pressed.

U.S. Pat. No. 4,974,956, issued Dec. 4, 1990 to Vicki L. Gill, shows an article holder for eyeglasses in which an elongated cord has opposite end portions and means for releasably connecting a cord to each temple bar of a pair of eyeglasses with the cord extending around the head or neck of the wearer. A sleeve is disposed in outer surrounding relation to the cord, the sleeve of a length to cover substantially the entire length of the cord and slidable with respect thereto. Adjusting means are engagable with an intermediate portion of the cord to extend through the sleeve for adjusting the effective length of the cord between a position fitting snugly around the head of the wearer and a position wherein the eyeglasses are loosely suspended from the neck of the wearer. Preferably the cord is composed of elastic material capable of stretching in a lengthwise direction and the sleeve is capable of undergoing expansion and contraction according to adjustments in the effective length of the cord.

U.S. Pat. No. 5,488,441, issued Jan. 30, 1996 to Thomas W. Pomatti, claims an eye-glass frame arrangement fabricated of a combination of a semi-rigid lens retaining support and a semi-flexible nose bridge and semi-flexible temple bows having a retaining strap removably engagable around the back of the head and adapted for use while engaging in activities which involve physical endeavor or usages on or around bodies of water. Closed cell shaped padding is applied to the lens supports facing the eye sockets. The arrangement is formed to have memory so that the lens supports are initially positioned away from the eye sockets and upon tightening of the retaining strap, the arrangement deforms to the shape of goggles so that the lens support padding seals around the eye sockets to protect the eyes of the user from the elements. In another arrangement, the eye pad is integrated with the lens support and hingedly attached to the temple bows.

U.S. Pat. No. 4,657,364, issued Apr. 14, 1987 to Edmond E. Murrell, describes an adjustable eyewear retainer of fabric-covered elastic form material, for holding eyeglasses and the like securely in place on a wearer's head, providing padding for the bow portions of the eyeglasses which fit behind the wearer's ears. A pair of tubular members, which fit over the downwardly curved bows of a pair of glasses, are attached to the respective forward ends of a pair of elastic straps at an acute angle. Mating pieces of hook-and-loop fastening material are provided on the rear ends of the straps to provide for adjustable fit and easy removal of the glasses as desired. Parts of the tubular members are lined with fabric, while a short rear end part of each tubular member may have a rubber-like inner surface to provide increased grip on the bows of a pair of glasses. Adhesive construction is used.

U.S. Pat. No. 3,588,960, issued Jun. 16, 1969 to Bingham A. McClellan, discloses a helical coil of monofilament nylon set in the form of a flexible and stretchable spring.

U.S. Pat. No. 2,184,425, issued May 6, 1938 to Donald E. Kimball, indicates an adjustable head band for eye protectors which is extremely light, may be readily adjusted for size with a limit of elastic extension.

U.S. Pat. No. 6,322,212, issued Nov. 27, 2001 to Eugene Kliot, puts forth an improved eyeglass retainer is disclosed, having an annular closure attaching to the eyeglass frames. The annular closure draws the material of the retainer over the attachment means of the retainer, and bunches and constricts it in front of the attachment means, so as to hide said attachment means from view, and to maintain a close fit of the retainer material with the eyeglass frames, even in the presence of winds and inertial forces. In an alternate embodiment, the annular closure in combination with retaining enclosures located on the eyeglass temple pieces secures the retainer to the temple pieces.

U.S. Pat. No. 5,926,855, issued Jul. 27, 1999 to Ralph Brodbeck, is for an adjustable elastic protective eyewear strap for swimwear goggles and the like includes an elongated elastic cord having an elastic core encased in a stretchable cover. The goggle strap uses a releasable lock providing quick and convenient length adjustment for the goggle strap. The goggle strap is used in conjunction with a pair of goggles to provide a dependable and durable method for securing the goggles to the user's head.

U.S. Pat. No. US D450,744 S, issued Nov. 20, 2001 to Rhoades et al., illustrates a design for eyewear having a wrap around retainer.

None of the prior art patents address both problems of providing a means for securing glasses while wearing the glasses for normal use and also for storing the glasses when not in use.

### SUMMARY OF THE INVENTION

An object of the present invention is to provide a spring-loaded roller in one or both arms of a pair of glasses with a retractable cord which can be used for securing the glasses to the head of the wearer while wearing the glasses by maintaining the cord in a tight configuration around the back of the wearer's head and also used for storing the glasses around the neck of the wearer at any desired length by extending the cord out from the arm or arms of the glasses to the desired length.

Another object of the present invention is to provide a retractable cord or cords which can be fully retracted into the arm or arms of the glasses to permit normal use of the glasses without a cord or elastic hanging off of the glasses.

In brief, a pair of eyeglasses including sun glasses has one or both arms of the glasses provided with an interior spring-loaded roller. A cord or cords extend through a channel and out an opening in the back of the arm or arms. A small sphere larger than the opening in the arm or arms or other element on the outer end of the cord or cords prevents the cord or cords from retracting into the arm or arms.

To attach a cord from a single spring-loaded roller in one arm to the other arm an opening with a slot or other receiving means is provided to receive and hold the sphere or other element on the end of the cord. To attach the ends of the cords from a spring-loaded roller in each arm of the glasses, a mating hook element is provided on the end of each cord and hooked together to secure the cords between the arms of the glasses.

A friction stop brake adjacent to the spring-loaded roller or rollers and extending out of the arm or arms of the glasses may be pushed in to hold the roller in place in a similar fashion to a tape measure holding means. This enables the cord to be extended and held in place at any desired length, such as shortened around the head for wearing the glasses while participating in activities, which may be done with the break released for a tension fit due to the spring-loaded roller or rollers, or extended longer for wearing the glasses around the neck for storage with the brake engaged to adjust the length of the extended cord.

An advantage of the present invention is that it enables both securing the glasses tightly around the head of the wearer for activities and also allows hanging the glasses around the neck for storage.

Another advantage of the present invention is that the cord or cords may be retracted fully to permit normal usage of the glasses without a hanging cord or elastic.

### BRIEF DESCRIPTION OF THE DRAWINGS

These and other details of my invention will be described in connection with the accompanying drawings, which are furnished only by way of illustration and not in limitation of the invention, and in which drawings:

FIG. 1 is a perspective view of the retractable cord eyeglasses having a spring-loaded roller in a single arm of the glasses;

FIG. 2 is a partial perspective view of the retractable cord eyeglasses of FIG. 1 showing the cord fully retracted with only the sphere on the end of the cord protruding;

FIG. 3 is a partial perspective view of the retractable cord eyeglasses of FIG. 1 showing the sphere at the end of the cord inserted into a circular opening having a slot for retaining the sphere in the other arm of the eyeglasses;

FIG. 4 is a partial perspective view showing an alternate embodiment of the roller having a double roller for the cord to enable the rolling up of a longer portion of cord in the same limited height of space as a single roller;

FIG. 5 is a perspective view of the retractable cord eyeglasses having a spring-loaded roller in a both arms of the glasses

### BEST MODE FOR CARRYING OUT THE INVENTION

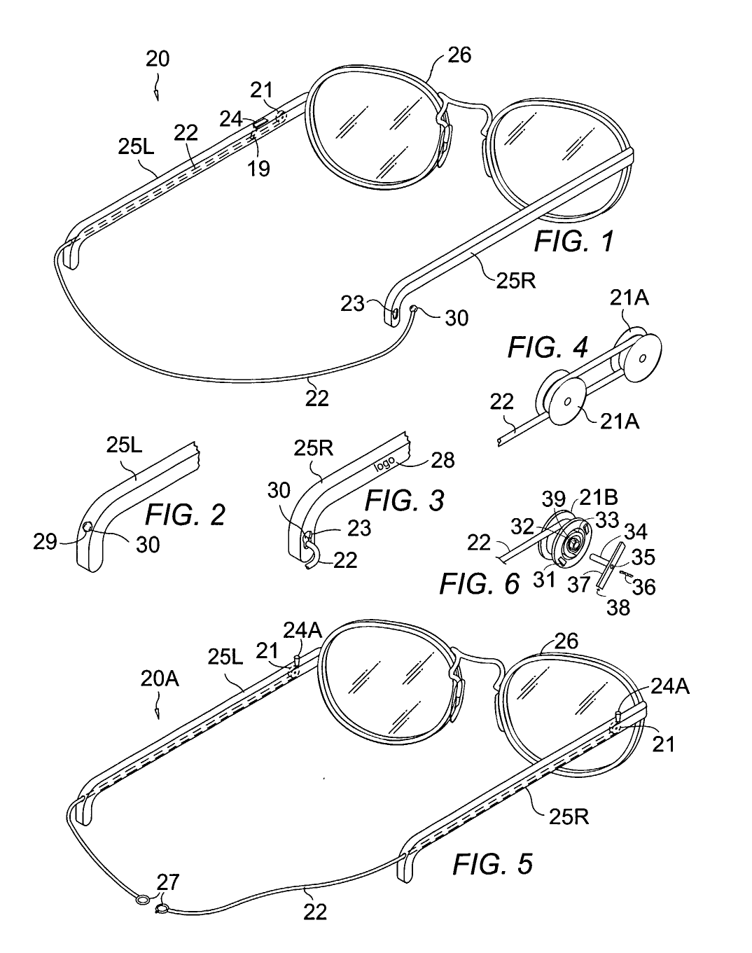

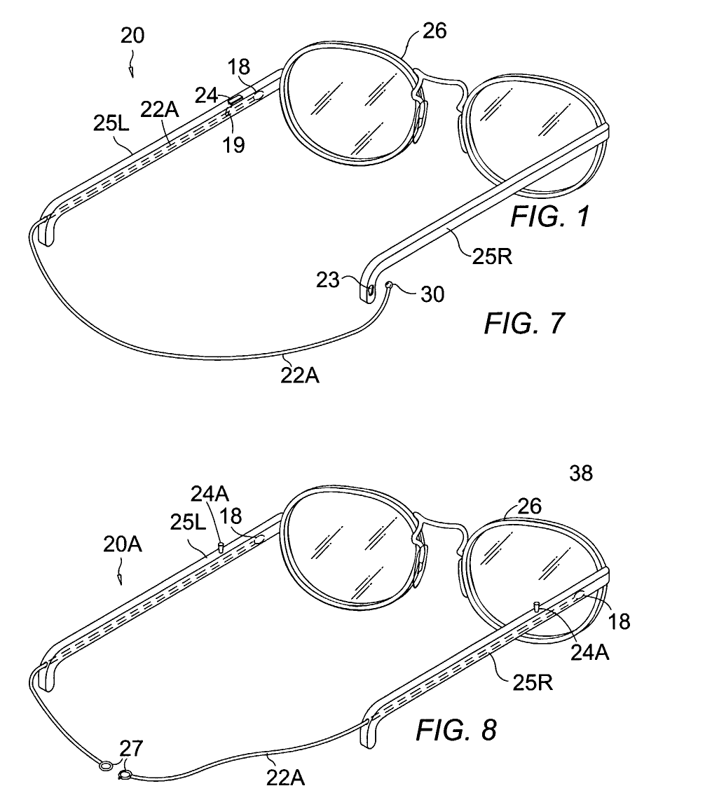

In FIG. 1, a retractable eyeglass holding device 20 a pair of eyeglasses comprising a viewing portion 26 and two arms 25L and 25R with at least one arm having a hollow interior space and a self-winding means disposed within the hollow interior space, such as a spring-loaded roller 21, and a cord means 22 capable of being stored within the self-winding means, the roller 21, and capable of being withdrawn from the self-winding means and extending out of the hollow interior space and being interconnected between the two arms 25L and 25R.

A lock means 24 for retaining the cord means 22 at a desired distance of extension from the at least one arm, the lock means capable of release permit retraction of the cord means into the hollow interior space. The lock means 24 comprises a brake in the form of a movable element, such as a pin, extending between the interior hollow space and an exterior of the device adjacent to the at least one spring-loaded roller 21 so that the movable element is capable of contacting the at least one spring-loaded roller 21 and preventing motion thereof, the movable means capable of being activated and deactivated by a user by manipulation of the movable element by pushing and pulling.

In FIG. 1 the device comprises at least one spring-loaded roller 21 on a single arm of the glasses, such as the left arm 25L, the cord having an end attachment, such as a sphere 30, incapable of fitting within the hollow interior space, the end attachment capable of interconnecting with a mating element on the other arm 25R of the glasses.

The single arm of the glasses further comprises an end opening 29 communicating between the hollow interior space and an exterior of the glasses and the end attachment, the sphere 30 is larger in diameter than the end opening 29, as seen in FIG. 2. The other arm, the right arm 25R in this case, comprises an end receiving opening 23, which could be a keyhole shaped opening with a circular portion, as seen in FIG. 3, to receive the sphere and a lower slotted portion to slide the sphere 30 down so that it will not pull out of the circular opening, at an end of the other arm, the receiving opening capable of receiving and retaining the sphere 30 therein to connect the cord means between the two arms 25L and 25R.

In FIG. 3 the arm 25R may be imprinted or embossed with a logo 28 or design or other indicia.

In FIG. 4 two spring-loaded rollers 21A may be used within one arm to store extra cord 22.

In FIG. 5 each arm 25L and 25R of the device has a hollow interior space and further comprising at least one spring-loaded roller 21 in each arm and two cord means 22 with each of the rollers capable of causing one of the cord means to roll up on the at least one spring-loaded roller for storage of the cord means thereon and each of the cord means further comprises a mating end attachment 27, such as mating hooks, capable of interconnecting with the mating attachment on the other cord means.

In FIG. 6 the spring loaded roller 21B has an interior coil spring 33 attached at an inner end to a hollow hub 32 protruding from a first side of the arm and at an outer to the roller 21B which receives the cord 22 rolled up thereon. A T-shaped stop 38 acts as a brake to stop the roller as soon as the cord is released from being retracted to maintain the cord at a desired length of retraction. The cross arm 37 of the T-shaped stop 38 fits within a notch 39 on an end of the hollow hub 32 and the outer ends of the cross arms engage the ramped protrusions 31 on the side of the roller 21B to stop the movement of the roller. The T-shaped stop 38 is forced against the roller by a small spring 36 contacting a second side of the arm. A pin 34 extending perpendicularly from the cross-arm 37 protrudes out an opening in the first side of the arm. Pushing the pin 34 into the arm releases the cross-arm 37 of the T-shaped stop from contacting the ramped protrusions and the roller 31B automatically rolls up the cord means 22.

In FIGS. 7 and 8, an elasticized cord means 22A attaches to the hollow interior space by an interior end attaching means 18 such as an end portion larger than the width of the cord device of claim 1 wherein the end portion fits within the arm 25L with a tight friction fit capable of anchoring the cord means therein.

In FIG. 7, a single arm 25L of the glasses has an elasticized cord means 22A and the arm further comprises an end opening 29 communicating between the hollow interior space and an exterior of the glasses and the end attachment, the sphere 30 is larger in diameter than the end opening 29, as seen in FIG. 2. The other arm, the right arm 25R in this case, comprises an end receiving opening 23, which could be a keyhole shaped opening with a circular portion, as seen in FIG. 3, to receive the sphere and a lower slotted portion to slide the sphere 30 down so that it will not pull out of the circular opening, at an end of the other arm, the receiving opening capable of receiving and retaining the sphere 30 therein to connect the cord means between the two arms 25L and 25R.

In FIG. 8 each arm 25L and 25R of the device has a hollow interior space and an elasticized cord means 22A in each arm attached by an end attaching means 18 and the two cord means 22 are capable of to rolling up in the for storage of the cord means therein and each of the elasticized cord means 22A further comprises a mating end attachment 27, such as mating hooks, capable of interconnecting with the mating attachment on the other cord means.

It is understood that the preceding description is given merely by way of illustration and not in limitation of the invention and that various modifications may be made thereto without departing from the spirit of the invention as claimed.

What is claimed is:

1. A retractable eyeglass holding device comprising:
a pair of eyeglasses comprising a viewing portion and two arms with at least one arm having a hollow interior space;
a cord means capable of being stored within the self-winding means and capable of being withdrawn from the self-winding means and extending out of the hollow interior space and being interconnected between the two arms and further capable of retracting into the hollow interior space.

2. The device of claim 1 further comprising a self-winding means, disposed within the hollow interior space, the self-winding means capable of retracting the cord means into the hollow interior space.

3. The device of claim 2, wherein the self-winding means comprises at least one spring-loaded roller capable of causing the cord means to roll up on the at least one spring-loaded roller for storage of the cord means thereon.

4. The device of claim 1 further a lock means for retaining the cord means at a desired distance of extension from the at least one arm, the lock means capable of release permit retraction of the cord means into the hollow interior space.

5. The device of claim 4 wherein the lock means comprises a brake means for retaining the cord means in a stationary position so that the cord means is not movable.

6. The device of claim 3 wherein the spring-loaded roller further comprises a ratchet means for retaining the spring loaded roller in a stopped position upon release of the cord means after a retraction of a portion of the cord means from the hollow interior space and a means for disengaging the ratchet to permit an automatic retraction of the cord means onto the spring-loaded roller.

7. The device of claim 1 comprising at least one retractable cord element on a single arm of the glasses, the cord having an end attachment incapable of fitting within the hollow interior space, the end attachment capable of interconnecting with a mating element on the other arm of the glasses.

8. The device of claim 7 wherein the single arm of the glasses further comprises an end opening communicating between the hollow interior space and an exterior of the glasses and the end attachment comprises a sphere larger in diameter than the end opening and the other arm comprises an end receiving opening at an end of the other arm, the receiving opening capable of receiving and retaining the sphere therein to connect the cord means between the two arms.

9. The device of claim 1 comprising two spring-loaded rollers within one arm.

10. The device of claim 1 wherein each arm of the pair of eyeglasses has a hollow interior space and further comprising at least one retractable cord means in each arm and each of the cord means further comprises a mating end attachment capable of interconnecting with the mating attachment on the other cord means.

11. The device of claim 10 wherein the mating end attachment comprises a hook element.

12. The device of claim 1 wherein the cord means comprises an elasticized cord attached within the hollow interior space.
